(19) United States
(12) Patent Application Publication
(10) Pub. No.: US 2016/0307465 A1
(43) Pub. Date: Oct. 20, 2016

(54) MULTILINGUAL LESSON BUILDING SYSTEM AND METHOD FOR LANGUAGE LEARNING

(71) Applicant: Orson Morris Tormey, Singapore (SG)

(72) Inventor: Orson Morris Tormey, Singapore (SG)

(21) Appl. No.: 15/130,937

(22) Filed: Apr. 16, 2016

Related U.S. Application Data
(60) Provisional application No. 62/148,545, filed on Apr. 16, 2015.

(51) Int. Cl. G09B 19/06; G09B 5/06

(52) U.S. Cl. CPC G09B 19/06; G09B 5/065

(57) ABSTRACT

A system and method for multilingual lesson building for language learning includes selection of the native language of a learner and a foreign language to be taught to the learner. An application software permits entering a phrase in the native language and a corresponding foreign language phrase wherein pronunciation, images, videos, stories and other interactive media are attached to each word of the foreign phrase to enable the learner to easily learn the language and build fluency in the foreign language.

### CROSS REFERENCE TO RELATED APPLICATIONS

Not Applicable

### TECHNICAL FIELD

The present document relates to computer assisted language learning and, in particular, to interactive lesson building system and method for language learning.

### BACKGROUND

Ability to understand and communicate in multiple languages is considered to provide great advantage in today's business world where people from different cultures and ethnicities transact at a global level. With ever increasing cross border transactions, non-native language acquisition has seen a manifold increase in demand with more and more people wanting to learn at least one other language. Even schools and colleges have started providing options of picking up a language as a subject.

Traditionally, languages have been taught by language experts to a group of people in a classroom environment. This classroom teaching of a language has a lot of disadvantages. First and foremost the content of the books used for teaching is fixed and the students find it very difficult to find specific usage or additional explanation beyond what is mentioned in the books. Moreover, books tend to carry limited or no exercises explaining each specific word or phrase and hence students find it next to impossible to develop fluency in a new language.

With the advent of computers and Internet, some of the problems in using books to teach languages have been overcome by providing a more informative environment to students. Someone wanting to know more about a word or a phrase can now search online and readily look for more details and easier explanation with respect to the word or phrase. However, even the computer assisted language learning systems known in the art, provide very limited interactive environment and most systems have fixed content. The language experts trying to teach a language find themselves at a disadvantage when they cannot build their own lessons or cannot provide additional explanation with respect to a word or a phrase. Even if they can somehow add more explanation from their side, such addition is limited to providing explanation of entire sentences or phrases and such explanation cannot be appended to each word. None of the systems that exist today, let the user tap on each word or syllable to understand its pronunciation, usage etc.

Further, research has shown that people are able to learn a word or a phrase faster and retain it in their memory for longer if they are provided interactive content like stories, conversation etc. involving the usage of such words or phrases. None of the computer assisted language-learning systems or methods known provide the flexibility of adding such stories, conversations or other interactive content to enhance the learning experience.

In order to ensure that language learning is made easy, interactive and more effective it is important to have a method and system that enables anyone teaching a language to build their own unique lessons and provides flexibility to add stories and other interactive content with respect to each word being taught.

### SUMMARY

Accordingly, the invention provides a multilingual lesson building system and method for language learning, where the system includes a computing device with a processing unit where a native language of a learner is selected along with a desired foreign language to be taught to the learner. The method further includes entering of a phrase in native language along with the corresponding phrase in foreign language, selecting each word of the foreign language phrase and adding explanatory content to it and thereby generating the lesson. Furthermore, generated lesson is sent to a server from where learner can access lessons through their access devices (computer, android, IOS, etc).

### BRIEF DESCRIPTION OF THE DRAWINGS

FIG. 1 is an illustrative embodiment of a flow diagram that depicts the various steps of the method described herein

FIG. 2 is an illustrative embodiment of a flow diagram that depicts the attaching of pronunciation to syllables when building a lesson.

FIG. 3 is an alternative embodiment of a flow diagram that depicts the method of attaching tone to syllables of each word when building a lesson.

FIG. 4a is an illustrative embodiment of an application program configured to utilize the method provided herein to build language lessons.

FIG. 4b is an illustrative embodiment of adding different color to tone marks

FIG. 5 is an illustrative embodiment of network architecture in accordance with the description provided herein.

### DETAILED DESCRIPTION

The interactive lesson building method for language learning described herein includes selection of a native language of a learner and a foreign language that needs to be taught to the learner. Thereafter, a phrase is entered in the native language of the learner and various related content such as pronunciation, images, sound files, video files etc. are added to explain the phrase to the learner in an interactive manner. With respect to the foreign language, the number of foreign words needed is selected and pronunciation and tone marks are attached to each of the syllables. The lessons may be built on a near real time basis and there may be complete freedom provided to the teacher to modify the lessons and new ones based on the need of the learner.

The embodiments herein and the various features and advantageous details thereof are explained with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the scope of this patent application should not be construed as limited to the illustrative embodiments.

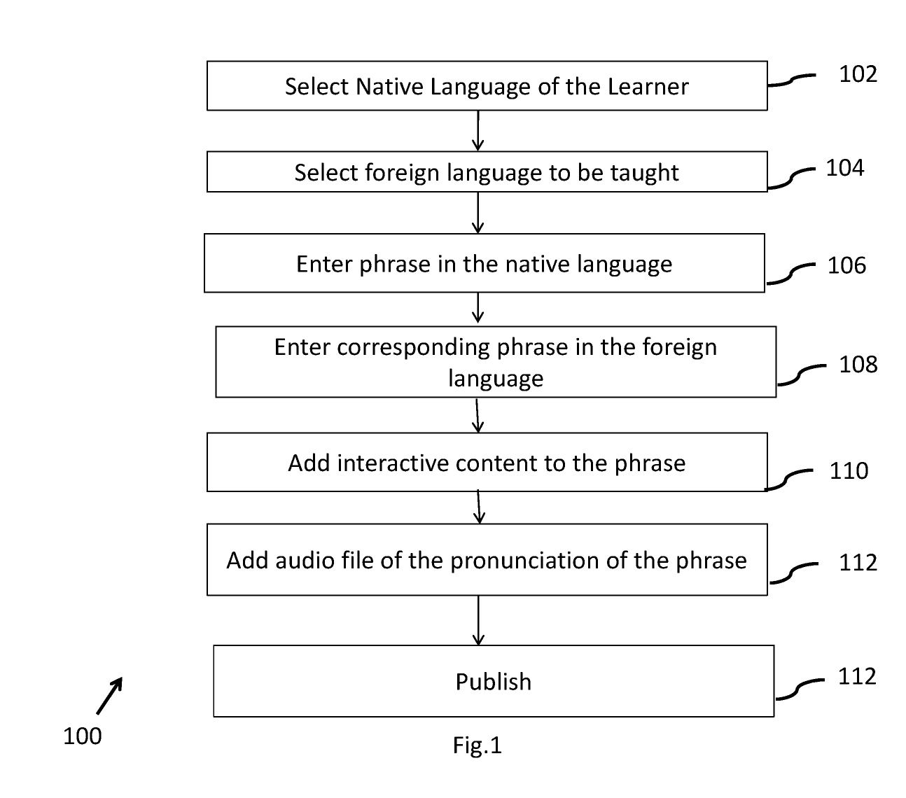

FIG. 1 is an illustrative embodiment of a flow diagram 100 that depicts the lesson building method described herein. In order to build a lesson, the native language of the learner is selected 102. Also, the foreign language to be taught to the learner is selected 104. Thereafter, the equivalent of a phrase to be taught in the foreign language is entered in the native language of the learner 106. The foreign equivalent of the phrase is entered 108 using foreign language input means such as language specific keyboards. The desired phrase of foreign language may be picked from an online bilingual dictionary or a database that is linked with the system. Optionally, explanatory content may be added to the phrase 110 for detailing purposes. This explanatory content may include interactive content such as images, sounds, videos etc, along with the pronunciations. The method further allows the identification of number of words needed in the foreign language text (not shown in the fig).

Furthermore, in one embodiment, pronunciation of each syllable of each word of the foreign language phrase may be added 112 and also syllable tone being taught can be selected from tone menu. Additionally, the method allows tone mark to be placed above the syllable or word which helps learners to understand which character to use a tone on. The process is carried on by coloring character the same color as the tone mark above it. This customized lesson with explanatory content (interactive content, pronunciation and tone together can be referred as ‘explanatory content’) is published and may be played back by the learner on a computing or mobile device including smart phones, tablets or any other web connected device whether known now or developed in the future.

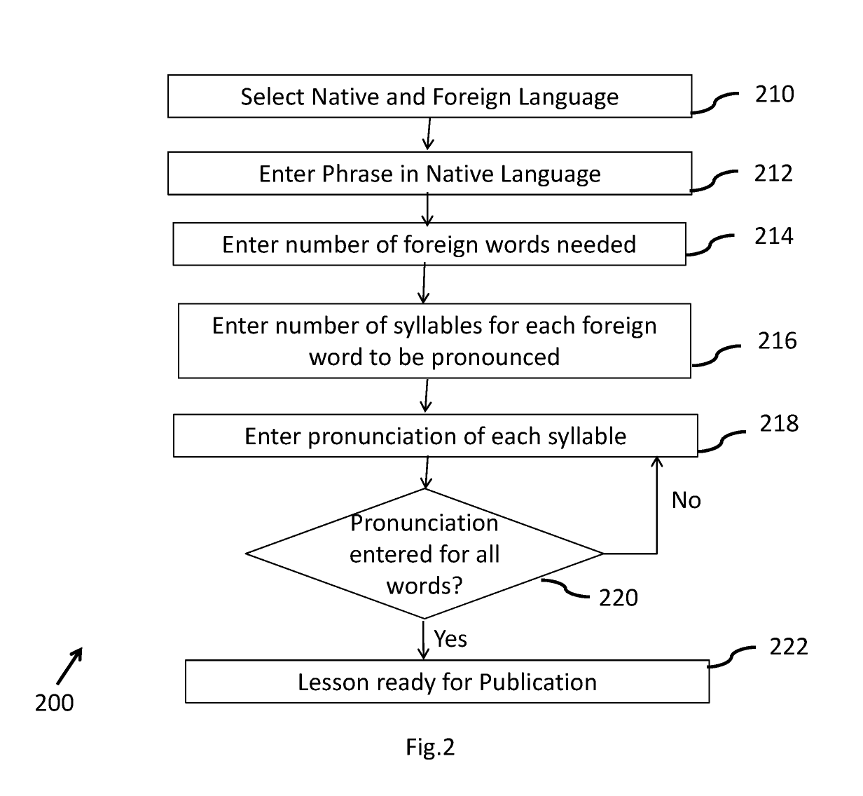

FIG. 2 is an illustrative embodiment of a flow diagram 200 that depicts the method of attaching pronunciation to a phrase during the building of a lesson. Once the native language of the learner and the foreign language to be taught are selected 210, a phrase is entered in the native language of the learner 212. Corresponding foreign equivalent of the phrase is added using a foreign language input means that is via typing and the number of words in the foreign phrase is identified 214. Each word is individually selected and the number of constituent syllables of each word is identified. Pronunciation of each syllable is recorded and added to the syllable 218. Optionally tone marks may be added to each syllable as well.

Once the pronunciation of all syllables of a word is added the next word of the foreign phrase is selected and the same process of adding pronunciation is followed. This process is followed until pronunciation for all words has been added 220. Once the pronunciation of the entire foreign phrase has been added, the lesson is bundled for publication 222.

In an alternate embodiment, the system may be configured to automatically pick specific portions from a sound file of the pronunciation of the foreign phrase and attach the segment of the audio to the specific word in the foreign phrase.

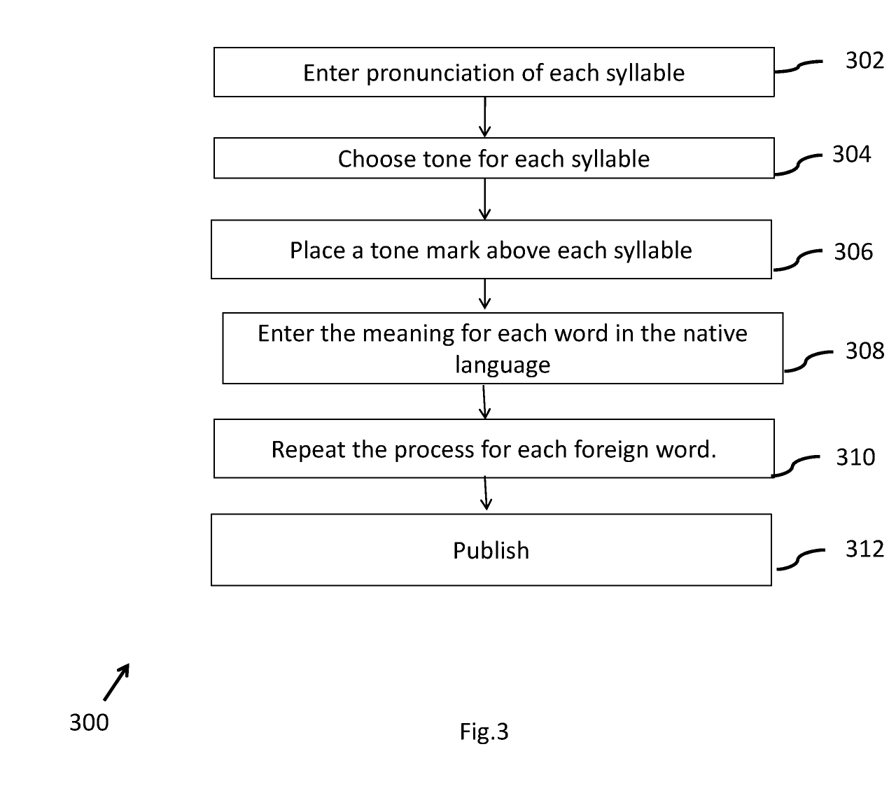

FIG. 3 is an alternate embodiment that depicts a flow diagram 300 of the method of attaching tone to syllables of each word when building a lesson. After attaching the pronunciation to each syllable 302 of foreign language, the method 300 optionally allows attaching of tone to each syllable 304 where the tone can be selected from the tone menu. The tone menu options are changed according to the language selected. Further, a tone mark can be placed above each syllable 306 which represents the course of the tone. For an example, there are different tone marks to represent normal, high, low, rising and falling tones. This feature of assigning tones would help students/learners to understand how to use tones on different characters which is assisted by the method of coloring the character with the same color as the tone mark above.

Once the tone is attached, the method 300 further allows entering the meaning of each foreign word in the learner's native language 308. The whole process is repeated 310 for each word in the foreign phrase and then the lesson is bundled for publication by transferring it to leaner's devices such as smart phones, tablets or any other web connected device whether known now or developed in the future via server (not shown in the FIG. 3)

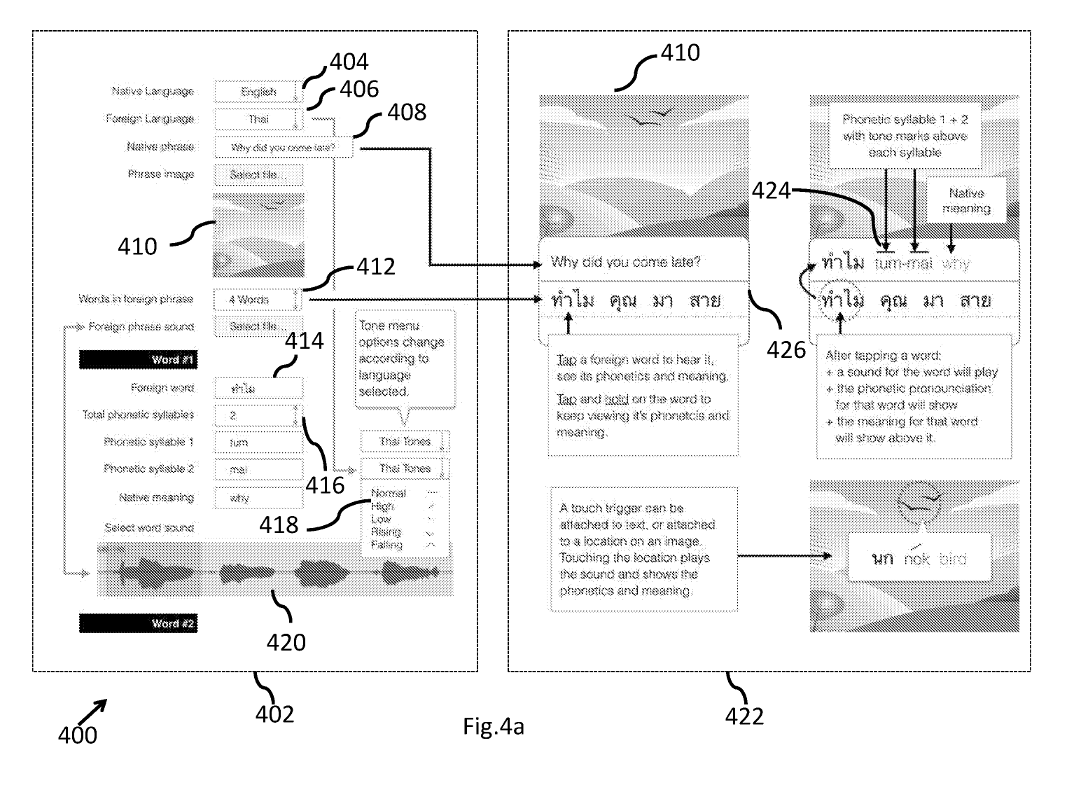

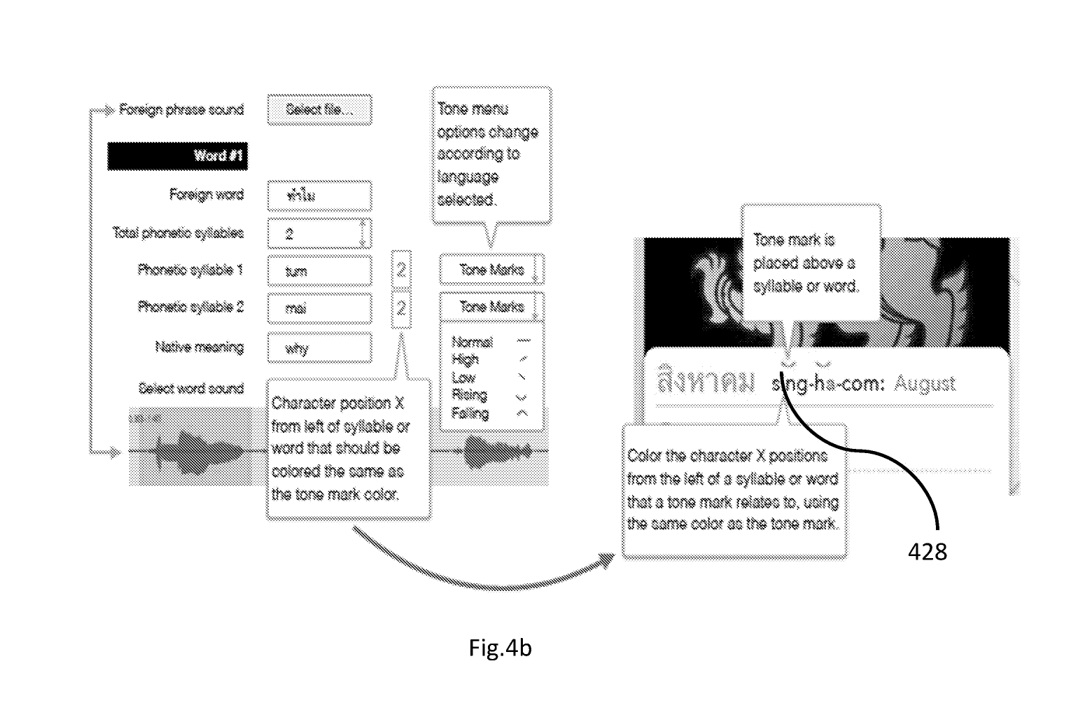

FIG. 4 depicts an illustrative embodiment of the application software that utilizes the method described herein to help users build lessons for language learning. The language building module 402 of the application software allows a user building a lesson to select the native language of the learner. In this specific example the native language is “English”. Further, the user is required to choose the foreign language 406 to be taught to the learner (“Thai” in this case). Thereafter, the user enters phrase to be taught in the native language of the user 308. In the example depicted, the phrase to be taught is “Why did you come late?” The user may optionally add interactive content such as an image 410 to the phrase 408 in order to better explain the phrase to the learner.

Once the corresponding equivalent phrase is added in the foreign language, the user enters the number of words 412 making up the foreign phrase. In an alternate embodiment, a bi-lingual dictionary or database may be linked wherein the equivalent foreign phrase is automatically picked from such dictionary or database and the number of words making up the foreign phrase are automatically counted. The dictionary or database may provide options regarding alternate foreign words that may be chosen corresponding to a specific word in the native language. In an alternate embodiment, the number of words making up the foreign phrase may be selected first and each word may be typed thereafter. The user then selects the first word 414 in the foreign phrase and the system breaks down the word 414 into its constituent syllables 416.

In an alternate embodiment, the word may be broken down into constituent syllables by the user instead of being automatically broken down by the system. Optionally, an audio file 420 consisting of the pronunciation of the entire foreign phrase may be attached in order to enable the learner to listen to the pronunciation of the entire phrase. The system permits the user to add pronunciation and tone marks for each syllable of the word 414. In one embodiment, the system permits the user to choose a tone for the syllables from a tone menu 418 available within the system. Here in the example there are five different tones which are represented by different marks 418. This process is repeated until pronunciation is assigned to all words/syllables of the foreign phrase. The system may be further configured to include additional modules such as user registration, billing, performance analysis and other such functional modules.

The learner accessing the lesson 422 on any device such as a computer, mobile phone, smart phone or tablet, views the phrase in his/her native language and in the corresponding foreign language 326 through a server. The learner is also able to view the image 310 or other interactive content attached by the teacher for a better understanding of the foreign language. The system is configured to provide the learner an option of tapping one of the words in the foreign phrase to understand its meaning and pronunciation and to see specific interactive content related to the words such as a story, conversation etc.

The learner may also get to see tone marks 424 above each syllable of the foreign word there by enabling the learner to grasp the pronunciation/tone and improve fluency in the foreign language. The proper pronunciation of a character may be identified easily by observing and matching the corresponding color of a character with the same tone mark color. In detail, color the character ‘X’ positions from the left of a syllable or word that a tone mark relates to, using the same color as the tone mark. FIG. 4b depicts an illustrative embodiment wherein a different color 428 is provided to tone mark and corresponding character is also of the same color. Multiple options such as playing sound associated with each word or syllable, looking up meaning of a specific word, listening to a story or a conversation involving a specific word may be made available to the learner.

In an alternate embodiment, a device's capacitive touch screen may be used to permit the learner to trigger the sound, meaning or other interactive content attached to a specific word in the foreign phrase. The ease of use of the interactive lesson building application 302 provides the teacher the capability to create effective lessons for language learning.

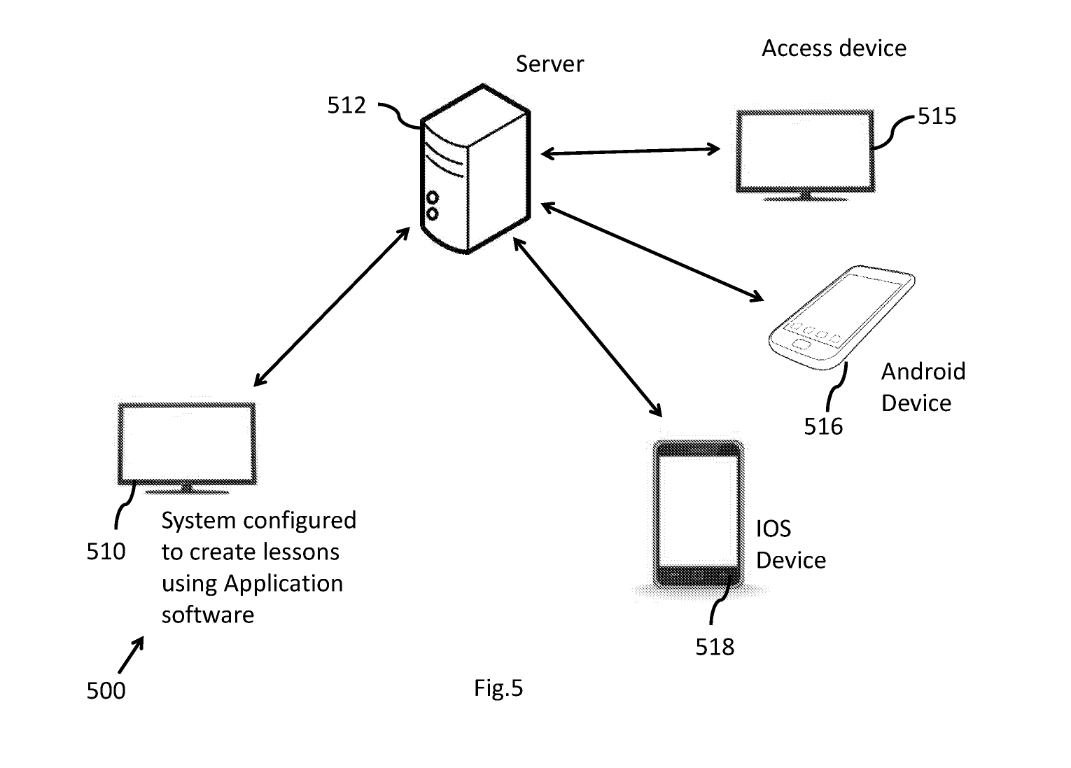

FIG. 5 is an illustrative embodiment of the network architecture 500 that permits the teacher to publish lessons on multiple platforms. A computing device 510 is configured to run the application program that permits a teacher to build language lessons. The computing device 510 possessing the application software selects a phrase in native language of learner and corresponding equivalent phrase in a foreign language. This computing device 510 may be a smart phone, tablet or any other commercially available device with a processor and computing capabilities. The computing device 510 may further include a processing device which is configured to attach explanatory content to words of said equivalent phrase of foreign language and generate a lesson. The lesson once created is saved on a server 512. The server may be a designated server or a cloud server. The server 512 may be accessed with the help of an Internet access device through a web browser. This makes the accessibility to the lesson device or operating system independent.

The stored lesson can be received to any access devices. The access devices are the devices with internet facility which includes on any computers 515, Android device 516, IOS Device 518 or devices running other operating systems now known or created in the future. These devices may access the lessons stored on the server via a Local Area Network (LAN) or a Wide Area Network (WAN) including Internet. The access devices may access these lessons that may be published or delivered in any way now known or developed in the future including but not limited to online publishing, online content delivery etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for multilingual lesson building for language learning, said method comprising:
selecting at least one native language of a learner;
selecting at least one foreign language to be taught to said learner;
entering a phrase in said native language;
entering an equivalent of said phrase in said foreign language;
selecting at least one word of said phrase in said foreign language;
adding one or more explanatory content to said word; and
generating of lesson in said foreign language.

2. The method for multilingual lesson building for language learning of claim 1 wherein said equivalent phrase in foreign language is chosen from a bilingual dictionary or database.

3. The method for multilingual lesson building for language learning of claim 1 wherein said explanatory content is pronunciations.

4. The method for multilingual lesson building for language learning of claim 1 wherein said explanatory content is images.

5. The method for multilingual lesson building for language learning of claim 1 wherein said explanatory content is sounds.

6. The method for multilingual lesson building for language learning of claim 1 wherein said explanatory content is videos.

7. The method for multilingual lesson building for language learning of claim 1 wherein said explanatory content is stories.

8. The method for multilingual lesson building for language learning of claim 1 further comprising identifying number of words of said foreign language.

9. The method for multilingual lesson building for language learning of claim 1 further comprising adding number of syllables for each word of said foreign language.

10. The method for multilingual lesson building for language learning of claim 1 further comprising choosing tones for syllables of each word of said foreign language.

11. The method for multilingual lesson building for language learning of claim 1 further comprising marking syllables of each word of said foreign language with a different color.

12. A system for multilingual lesson building for language learning, said system comprising:
a computing device configured to select an equivalent phrase in at least one foreign language corresponding to a phrase entered in at least one native language;
a processing unit disposed within said computing device said processing unit configured to attach explanatory content to at least one word of said equivalent phrase in said foreign language and generate a lesson;
a server in contact with said computing system configured to store said generated lesson; and
at least one access device configured to access lessons from said server.

13. The system for multilingual lesson building for language learning of claim 12 wherein said access device is a computer.

14. The system for multilingual lesson building for language learning of claim 12 wherein said access device is a mobile device.

15. The system for multilingual lesson building for language learning of claim 12 wherein said computing system is enabled with application software configured to instruct said processing unit to attach said explanatory content.

16. The system for multilingual lesson building for language learning of claim 12 wherein said explanatory content is pronunciations.

17. The system for multilingual lesson building for language learning of claim 12 wherein said explanatory content is images.

18. The system for multilingual lesson building for language learning of claim 12 wherein said explanatory content is sounds.

19. The system for multilingual lesson building for language learning of claim 12 wherein said explanatory content is videos.

20. The system for multilingual lesson building for language learning of claim 12 wherein said explanatory content is stories.

21. The system for multilingual lesson building for language learning of claim 12 further comprising said processing unit further configured to identify number of words of said foreign language.

22. The system for multilingual lesson building for language learning of claim 12 further comprising said processing unit further configured to add number of syllables for each word of said foreign language.

23. The system for multilingual lesson building for language learning of claim 12 further comprising said processing unit further configured to choose tones for syllables of each word of said foreign language.

24. The system for multilingual lesson building for language learning of claim 12 further comprising said processing unit further configured to mark syllables of each word of said foreign language with a different color.
